(19) United States
(12) Patent Application Publication
(10) Pub. No.: US 2003/0094721 A1
(43) Pub. Date: May 22, 2003

(54) Foamed polishing sheet and method of producing same

(75) Inventors: Yuji Horie, Tokyo (JP); Hiromitsu Okuyama, Tokyo (JP); Naoyuki Hamada, Tokyo (JP)

Correspondence Address: BEYER WEAVER & THOMAS LLP, P.O. BOX 778, BERKELEY, CA, 94704-0778, US

(73) Assignee: Nihon Microcoating Co., Ltd.

(21) Appl. No.: 10/272,666

(22) Filed: Oct. 15, 2002

(30) Foreign Application Priority Data
Mar. 1, 2002 (WO) PCT/JP02/01930
May 9, 2001 (JP) 2001-138972

(51) Int. Cl. B32B 3/26

(52) U.S. Cl. 264/41; 428/304.4

(57) ABSTRACT

A foamed polishing sheet for use in a free particle polishing method using abrading particles with average particle diameter less than 0.1 μm is produced by applying a foaming paint of a foaming resin on a surface of a form-providing film such as a plastic film, foaming the foaming paint by a wet foaming method to form a foamed sheet on the surface of the form-providing film, and peeling off the foamed sheet from the form-providing film so as to form a polishing surface on the foamed sheet having the same shape as the surface of the form-providing film.

### BACKGROUND OF THE INVENTION

This invention relates to a foamed polishing sheet for polishing the surface of a material such as metals, ceramics, plastics and glass, as well as a method of producing such a polishing sheet. In particular, this invention relates to a foamed polishing sheet for polishing a precision-requiring component such as a color filter for a liquid crystal display device, an optical lens and a magnetic disk substrate requiring a high degree of smoothness, as well as a method of producing such a polishing sheet.

If such a precision-requiring component has unwanted scratches or protrusions on its surface, it can no longer function in the way anticipated on the basis of its design. Thus, the polishing process for producing a smooth surface is an important step in the production of such a component, determining the functional properties of the component.

A magnetic disk serving as a magnetic memory medium, for example, is produced by texturing the surface of a substrate made of an aluminum alloy or a glass material such that the surface will have a specified degree of surface roughness and then by forming a magnetic layer and a protection layer on this surface. Before the texturing process is carried out, the surface is made smooth by a mirror polishing process.

A so-called free particle polishing method is usually used for such a process, using a polishing slurry having abrading particles of diamond, cerium oxide, aluminum oxide, silicon oxide, silicon carbide, zirconium oxide, chromium oxide, titanium oxide or iron oxide with average diameter equal to or less than about 5 μm dispersed in water or a water-based aqueous solution. A chemical mechanical polishing (CMP) process is also carried out by using a polishing slurry containing also an acid or alkaline material reacting chemically with the material of the substrate surface. The CMP is a kind of free particle polishing method whereby a solid-state reaction is caused on the contact surface between a solid material and a target object of the polishing in order to generate a different substance on this contact surface and a polishing process is carried out while removing the portion of the contact surface. Since the polishing unit is very small, the target surface can be smoothed to a high degree by such a process. Another advantage of this method is that the material deterioration due to the polishing is extremely small because the polishing is effected by making use of a chemical reaction.

The free particle polishing process is usually carried out by causing a polishing slurry as explained above to be present between a polishing member obtained by cutting a polishing sheet into the form of a tape or a pad or in some other form and the target surface of an object to be polished and moving them mutually with respect to each other. Examples of polishing sheet for use in a free particle polishing process include foamed sheets obtained by forming a foamed layer of a foamed urethane resin on the surface of a plastic film comprising polyethylene terephthalate (PET) or polyester (as disclosed in Japanese Patent Publication Tokkai 8-248756). Such foamed sheets with a foamed layer are being used not only for the mirror polishing of magnetic disk substrates but also for the surface finishing of precision-requiring components such as liquid crystal glass substrates and optical lenses.

Since such foamed sheets are produced merely by foaming a paint material comprising a foaming resin applied on the surface of a plastic film by a dry or wet method, the thickness of the foamed layer is not uniform and its surface is not even. Thus, a common practice has been to remove surface portions of the foamed layer in a buffing process or by means of a knife after the foamed layer is formed to accomplish a smooth suede finish. After such a surface processing is effected, air bubbles generated internally when the foaming resin material becomes foamed come to be externally exposed such that openings with diameters about 20-100 μm appear on the polishing surface. When a free particle polishing process is carried out by using such a foamed sheet, the abrading particles in the polishing slurry supplied between the polishing surface and the surface of the target object of the polishing are maintained within such openings and the polishing is effected by such abrading particles maintained in these surface openings.

Recently, smaller abrading particles with average diameters less than 0.1 μm are coming to be used for polishing surfaces of precision-requiring components ever more smoothly. With a prior art foamed sheet with a foamed layer as described above, however, the openings formed on the polishing surface are too big to maintain such smaller abrading particles. Such smaller abrading particles are taken inside the relatively larger openings. As a result, the effective number of abrading particles actually participating in the polishing of the target surface to be polished is reduced and the so-called stock removal per unit time is adversely affected. Thus, the time required for the polishing becomes longer and the problem arises that a uniform polishing work cannot be dependably effected.

### SUMMARY OF THE INVENTION

It is therefore an object of this invention to provide a foamed polishing sheet capable of polishing a target surface smoothly and with a higher stock removal rate by a free particle polishing method using abrading particles with average particle diameter of less than 0.1 μm.

It is another object of this invention to provide a method of producing such a foamed sheet.

A foamed polishing sheet embodying this invention with which the above and other objects can be accomplished may be characterized as being formed by applying a foaming paint made of a foaming resin material on the surface of a form-providing film such as a plastic film, forming a foamed sheet on the surface of this form-providing film by causing this foaming paint to be foamed by a wet foaming method, removing this foamed sheet from the form-providing film to thereby form a polishing surface on the foamed sheet in the shape of the surface of the form-providing film. The foaming paint mentioned above is a foaming resin solution having a foaming resin material such as foaming urethane resin dissolved in a solvent.

### BRIEF DESCRIPTION OF THE DRAWINGS

FIG. 1 is a sectional view of a polishing sheet according to this invention being separated from a form-providing film.

FIGS. 2A and 2B are respectively a plan view of a lower lapping plate and an upper lapping plate of a double-side lapping machine which may be used for a polishing process using a polishing sheet of this invention.

### DETAILED DESCRIPTION OF THE INVENTION

The invention is described next by way of an example.

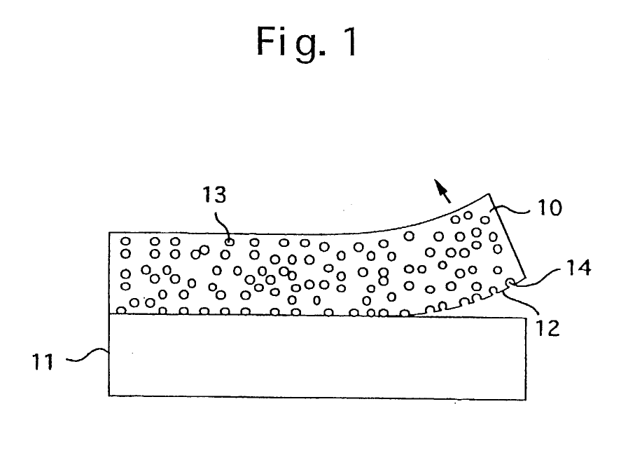

FIG. 1 shows a foamed polishing sheet 10 being produced by applying a foaming paint comprising a foaming resin material on the surface of a form-providing film 11, causing this forming paint to be foamed by a wet foaming method to form a foamed sheet on the surface of the form-providing film 11 and removing this foamed sheet from the surface of the form-providing film 11. The foaming paint mentioned above is a foaming resin solution having a foaming resin material such as foaming urethane resin dissolved in a solvent. The solvent may be an organic solvent such as dimethyl formamide. If necessary, a foaming assistant agent such as water and fleon as well as a form stabilizer such as silicone oil may be added.

The wet method of foaming the foaming paint applied on the surface of the form-providing film 11 is carried out by substituting the solvent in the paint with water and then drying the substituted paint to thereby evaporate the water component. As the solvent of the paint is substituted with water, very small water bubbles are formed inside the foaming paint. As this is dried and the water component is evaporated, very small air bubbles 13 are formed inside the foaming sheet. If the foaming sheet thus prepared is thereafter removed from the form-providing film 11, those of the very small air bubbles 13 on the boundary surface between the form-providing film 11 and the foamed sheet become externally exposed, appearing on a polishing surface 12 as very small openings 14 with diameters smaller than 5 μm. These openings 14 serve to hold abrading particles during the course of a free particle polishing process.

Examples of the aforementioned form-providing film 11 include flexible plastic films which can be easily separated from the foamed sheet such as films of polyethylene terephthalate (PET), polypropylene, polyethylene, vinyl oxide and polyester with thickness about 5-500 μm.

Since the polishing surface of the foamed sheet embodying this invention is formed along the surface of the form-providing film, it can be made flat and smooth if a form-providing film with a flat and smooth surface is used. Thus, there is no need to carry out a surface treatment of the kind required in the prior art technology described above. Use may also be made of a form-providing film with indentations and protrusions formed on its surface by an embossing process for producing polishing surfaces in a linear form, a curved form or a dotted pattern with mutually separated protrusions.

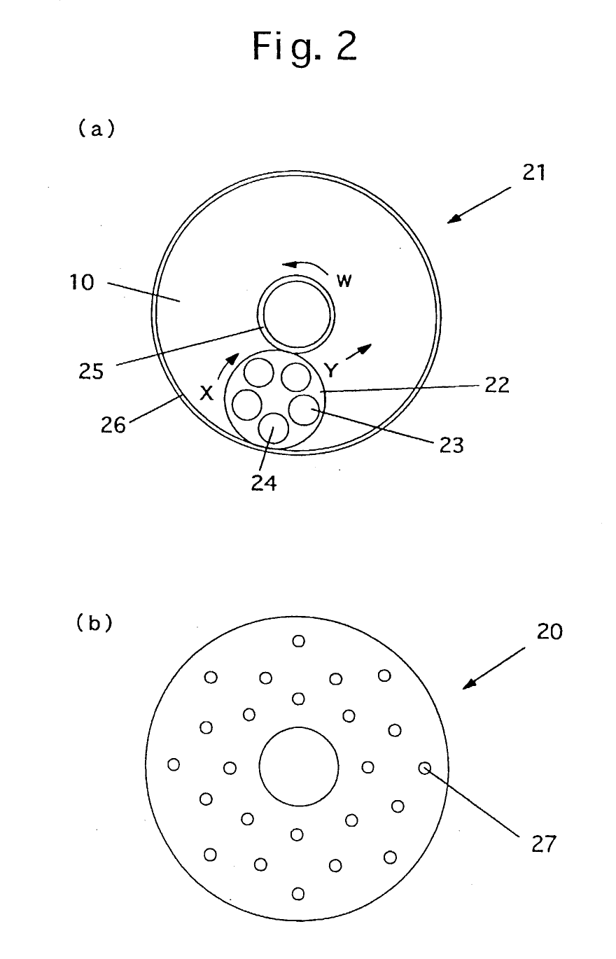

The foamed polishing sheet 10 thus produced may be cut into the shape of a pad or a tape to be used for the polishing of precision-requiring components. For the polishing of a substrate for a magnetic disk, for example, use may be made of a single-side or double-side polisher (or lapping machine) of a known kind. FIGS. 2A and 2B show an example of double-side polisher which may be used with a polishing sheet of this invention, comprising a donut-shaped lower lapping plate 21 and a similarly shaped upper lapping plate 20. A foamed polishing sheet 10 is attached to each of these plates 20 and 21. A sun gear 25 connected to an external driver motor is positioned at the center of both the upper and lower lapping plates 20 and 21 and an internal gear 26 is affixed to the circumference of the lower lapping plate 21. A planet gear 22 is disposed on the foamed polishing sheet 10 attached to the lower lapping plate 21, engaging both with the sun gear 25 and the internal gear 26, as shown in FIG. 2A. Substrates 24 to be polished are placed individually inside a plurality of openings 23 formed in the planet gear 22 and pressed from above by the upper lapping plate 20. The upper lapping plate 20 is provided with a plurality of holes 27, through which a suspension containing abrading particles (or the polishing slurry) is supplied into the space between the upper and lower lapping plates 20 and 21.

Polishing of the substrates 24 thus placed in the openings 23 of the planet gear 22 is effected in a batch form by rotating the sun gear 25 in the direction of the arrow W while supplying the polishing slurry into the space between the upper and lower lapping plates 20 and 21 through the holes 27 in the upper lapping plate 20, thereby causing the planet gear 22 to undergo not only an autorotation in the direction of the arrow X but also a revolution in the direction of the arrow Y between the upper and lower lapping plates 20 and 21.

The polishing slurry is obtained by dispersing abrading particles within a liquid such as water, alcohol, an organic solvent or a solution having any of these as its base. Examples of the abrading particles include particles of one or more kinds selected from a group including diamond, cerium oxide, aluminum oxide, silicon oxide, silicon carbide, zirconium oxide, chromium oxide, titanium oxide and iron oxide with average diameter less than 0.1 μm. An alkaline or acid solution which reacts chemically with the surface of the target object to be polished may be added to the polishing slurry for carrying out the chemical mechanical polishing.

The invention is described next with reference to actual experiments.

A foamed polishing sheet was produced according to this invention as follows. Foaming urethane resin (48 weight %) and dimethyl formamide (25 weight %) were mixed together and additives (27 weight %) such as a foaming assistant agent and a stabilizing agent were added to produce a foaming paint, and this paint was applied to the surface of a PET film (serving as a form-providing film). After this film was passed inside water, it was dried for 5 minutes to form a foamed urethane sheet on the surface of the PET film. A foamed sheet according to the invention was obtained by peeling off this foamed urethane sheet from the PET film.

As a comparison experiment, a prior art foamed sheet was produced and used in a free particle polishing process on a magnetic disk substrate of an aluminum alloy with a Ni-P plating. Its polishing characteristics such as the rate of stock removal, average surface roughness and surface waviness were compared with those of the foamed sheet according to this invention.

This prior art foamed sheet was produced by mixing 48 weight % of foaming urethane resin and 25 weight % of dimethyl formamide, adding 27 weight % of additives such as a foaming assistant agent and a stabilizing agent to produce a foaming paint, applying this paint to the surface of a PET film (serving as a form-providing film), passing this film inside water and thereafter drying it for 5 minutes to form a foamed urethane sheet on the surface of the PET film and removing surface portions of the foamed urethane layer by a buffing process.

The double-side lapping machine described above with reference to FIGS. 2A and 2B were used for the free particle polishing under the conditions shown below in Table 1. Polishing slurries A and B having abrading particles (aluminum oxide particles with average diameter 0.1 μm for A and silica particles with average diameter 0.05 μm for B) dispersed in water were used.

TABLE 1

| | |
|---|---|
| Rotary speed of lapping plates | 40 rpm |
| Applied pressure | 90 g/cm² |
| Supply rate of polishing slurry | 400 ml/minute |
| Stock removal (from each surface) | 0.5 μm |

After each process of free particle polishing, the polished substrates were taken out of the polisher and washed with water. A scanning probe microscope (Nanoscope Dimension 3100 Series, produced by Digital Instruments Corporation) was used to scan an arbitrarily selected area of 30 μm×30 μm on the polished surface of each substrate at 256 points, and the average surface roughness Ra was obtained within this scanned area. A white-light microscope (New View 5020 produced by Zygo Corporation) was also used to measure the waviness (Wa) within an arbitrarily selected test area of 0.87 mm×0.65 mm. The results of these measurements are shown in Table 2. In Table 2, the stock removal indicates the depth (in μm) polished per unit time. The scratches were viewed by applying a beam of spot light in a dark room after the polishing to determine visually the presence or absence of scratches.

TABLE 2

| | Stock | | | |
|---|---|---|---|---|
| | removal | | | |
| Foamed sheets | (μm/minute) | Ra(Å) | Wa(Å) | Scratches |
| Test Example | 0.22 | 1.9 | 6.8 | Somewhat visible |
| with slurry A | | | | |
| Comparison | 0.15 | 1.8 | 7.3 | Somewhat visible |
| Example with | | | | |
| slurry A | | | | |
| Test Example | 0.34 | 1.8 | 6.6 | Not visible |
| with slurry B | | | | |
| Comparison | 0.23 | 2.5 | 10.2 | Not visible |
| Example with | | | | |
| slurry B | | | | |

Table 2 shows that the substrate surfaces can be polished equally well or more smoothly and the polishing can be effected with a stock removal about 1.5 times greater if a foamed sheet embodying the invention is used instead of a prior art foamed sheet.

In summary, since a foamed sheet is peeled off from a form-providing film on which it is formed and this surface is directly used as the polishing surface, a flat and smooth polishing surface can be obtained without the trouble of carrying out a buffing process or removing portions of the surface by a knife or other means. Since small abrading particles with average diameter less than 0.1 μm can be retained in small openings formed on the polishing surface, furthermore, a target surface can be polished more efficiently with a high stock removal rate.

What is claimed is:

1. A method of producing a foamed polishing sheet, said method comprising the steps of:
applying a foaming paint comprising a foaming resin on a surface of a form-providing film;
foaming said foaming paint by a wet foaming method to thereby form a foamed sheet on said surface of said form-providing film; and
peeling off said foamed sheet from said surface of said form-providing film to thereby form a polishing surface on said foamed sheet, said polishing surface having a shape along said surface of said form-providing film.

2. The method of claim 1 wherein said form-providing film is a plastic film.

3. The method of claim 1 wherein said foaming resin comprises foaming urethane resin.

4. A foamed polishing sheet produced by a method comprising the steps of:
applying a foaming paint comprising a foaming resin on a surface of a form-providing film;
foaming said foaming paint by a wet foaming method to thereby form a foamed sheet on said surface of said form-providing film; and
peeling off said foamed sheet from said surface of said form-providing film to thereby form a polishing surface on said foamed sheet, said polishing surface having a shape along said surface of said form-providing film.

5. The foamed polishing sheet of claim 4 wherein said form-providing film is a plastic film.

6. The foamed polishing sheet of claim 4 wherein said foaming resin comprises foaming urethane resin.
